(19) United States
(12) Patent Application Publication
(10) Pub. No.: US 2019/0179102 A1
(43) Pub. Date: Jun. 13, 2019

(54) THREE-DIMENSIONAL SHAPING APPARATUS, CONTROL METHOD OF THREE-DIMENSIONAL SHAPING APPARATUS, AND CONTROL PROGRAM OF THREE-DIMENSIONAL SHAPING APPARATUS

(71) Applicant: KANTATSU CO., LTD., Yaita-shi (JP)

(72) Inventors: Eiji OSHIMA, Tochigi (JP); Akio SAKUMA, Fukushima (JP)

(21) Appl. No.: 16/146,851

(22) Filed: Sep. 28, 2018

(30) Foreign Application Priority Data
Dec. 7, 2017 (JP) 2017-235355

(51) Int. Cl. G02B 7/02; B29C 64/264; B29C 64/393; B29C 64/135; B33Y 30/00; B33Y 50/02

(52) U.S. Cl. CPC G02B 7/023; G02B 7/022; G02B 7/026; B33Y 50/02; B29C 64/393; B29C 64/135; B33Y 30/00; B29C 64/264

(57) ABSTRACT

Attachment of a lens unit is selected to implement large-size shaping and small-size high-resolution shaping by one apparatus. There is provided a three-dimensional shaping, apparatus including an attachment mechanism and an adjustment mechanism. The attachment mechanism of the three-dimensional shaping apparatus attaches, to a predetermined position, a lens unit that condenses a light beam from a light source. The adjustment mechanism of the three-dimensional shaping apparatus adjusts a position of the light source in accordance with the attached lens unit.

### CROSS-REFERENCE TO RELATED APPLICATION

This application is based upon and claims the benefit of priority from Japanese patent application No. 2017-235355, filed on Dec. 7, 2017, the disclosure of which is incorporated herein in its entirety by reference.

### BACKGROUND OF THE INVENTION

### Field of the Invention

The present invention relates to a three-dimensional shaping apparatus, a control method of the three-dimensional shaping apparatus, and a control program of the three-dimensional shaping apparatus.

### Description of the Related An

In the above technical field, patent literature 1 discloses a technique of providing a condenser lens in an irradiator.

[Patent Literature 1] Japanese Patent Laid-Open No. 8-230048

### SUMMARY OF THE INVENTION

In the technique described in the above literature, however, it is impossible to select attachment of a lens unit, thereby making it impossible to implement large-size shaping and small-size high-resolution shaping by one apparatus.

The present invention enables to provide a technique of solving the above-described problem.

One example aspect of the present invention provides a three-dimensional shaping apparatus comprising:

an attachment mechanism that attaches, to a predetermined position, a lens unit that condenses a light beam from a light source; and

an adjustment mechanism that adjusts a position of the light source in accordance with the attached lens unit.

Another example aspect of the present invention provides a control method of a three-dimensional shaping apparatus including

an attachment mechanism that attaches, to a predetermined position, a lens unit that condenses a light beam from a light source, and

an adjustment mechanism that adjusts a position of the light source in accordance with the attached lens unit,

the attachment mechanism including a moving mechanism that can move the lens unit between an attachment position of the lens unit and a non-attachment position of the lens unit,

the method comprising:

driving the moving mechanism to move between the attachment position of the lens unit and the non-attachment position of the lens unit;

driving the adjustment mechanism to adjust the position of the light source between a first position of the light source obtained when the lens unit is attached and a second position of the light source obtained when the lens unit is not attached; and

controlling the driving the moving mechanism and the driving the adjustment mechanism to synchronize with each other.

Still other example aspect of the present invention provides a control program of a three-dimensional shaping apparatus including

an attachment mechanism that attaches, to a predetermined position, a lens unit that condenses a light beam from a light source, and

an adjustment mechanism that adjusts a position of the light source in accordance with the attached lens unit,

the attachment mechanism including a moving mechanism that can move the lens unit between an attachment position of the lens unit and a non-attachment position of the lens unit,

the program for causing a computer to execute a method, comprising:

driving the moving mechanism to move between the attachment position of the lens unit and the non-attachment position of the lens unit;

driving the adjustment mechanism to adjust the position of the light source between a first position of the light source obtained when the lens unit is attached and a second position of the light source obtained when the lens unit is not attached; and

controlling the driving the moving mechanism and the driving the adjustment mechanism to synchronize with each other.

According to the present invention, it is possible to select attachment of a lens unit, thereby making it possible to implement large-size shaping and small-size high-resolution shaping by one apparatus.

### BRIEF DESCRIPTION OF THE DRAWINGS

FIG. 1A is a view showing the arrangement of the attachment mechanism of a three-dimensional shaping apparatus according to the first example embodiment of the present invention;

FIG. 1B is a view showing the overall arrangement of the three-dimensional shaping apparatus according to the first example embodiment of the present invention;

FIG. 2A is a view showing the overall arrangement of a three-dimensional shaping apparatus according to the second example embodiment of the present invention;

FIG. 2B is a partially enlarged view showing an example of the attachment mechanism of the three-dimensional shaping apparatus according to the second example embodiment of the present invention;

FIG. 2C is a partially enlarged view showing another example of the attachment mechanism of the three-dimensional shaping apparatus according to the second example embodiment of the present invention;

FIG. 3 is a partially enlarged view showing an example of the attachment mechanism of a three-dimensional shaping apparatus according to the third example embodiment of the present invention;

FIG. 4A is a partially enlarged view showing an example of the attachment mechanism of a three-dimensional shaping apparatus according to the fourth example embodiment of the present invention;

FIG. 4B is a partially enlarged view showing another example of the attachment mechanism of the three-dimensional shaping apparatus according to the fourth example embodiment of the present invention;

FIG. 5A is a partially enlarged view showing an example of the attachment mechanism of a three-dimensional shaping apparatus according to the fifth example embodiment of the present invention;

FIG. 5B is another partially enlarged view showing an example of the attachment mechanism of the three-dimensional shaping apparatus according to the fifth example embodiment of the present invention;

FIG. 6 is a table showing an example of a synchronization table provided in the three-dimensional shaping apparatus according to the fifth example embodiment of the present invention; and

FIG. 7 is a flowchart illustrating the operation procedure of the three-dimensional shaping apparatus according to the fifth example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

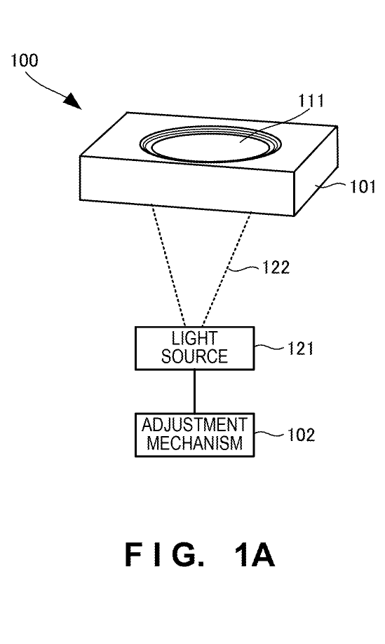

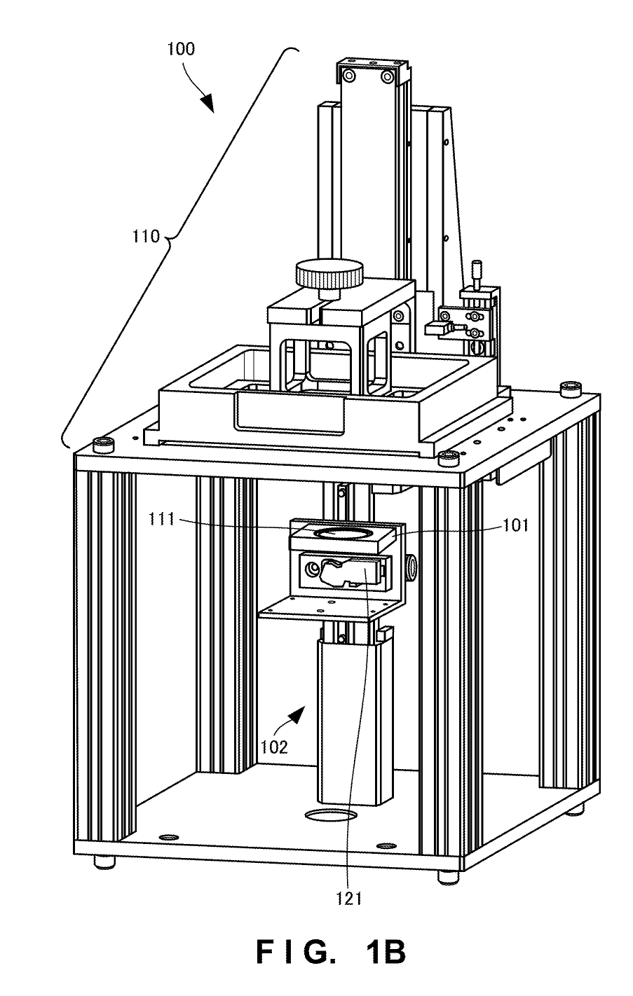

A three-dimensional shaping apparatus 100 according to the first example embodiment of the present invention will be described with reference to FIGS. 1A and 1B. The three-dimensional shaping apparatus 100 is an apparatus that shapes a three-dimensional shaped object by irradiating a material of the three-dimensional shaped object with a light beam.

As shown in FIGS. 1A and 1B, the three-dimensional shaping apparatus 100 includes an attachment mechanism 101, an adjustment mechanism 102, and a shaping unit 110. The attachment mechanism 101 attaches, to a predetermined position, a lens unit 111 that condenses a light beam 122 from a light source 121. The adjustment mechanism 102 adjusts the position of the light source 121 in accordance with the attached lens unit 111. In the shaping unit 110, the material of the three-dimensional shaped object is irradiated with the light beam 122 from the light source 121. Then, the three-dimensional shaped object is shaped in the shaping unit 110.

According to this example embodiment, it is possible to implement large-size shaping and small-size high-resolution shaping by one apparatus.

### Second Example Embodiment

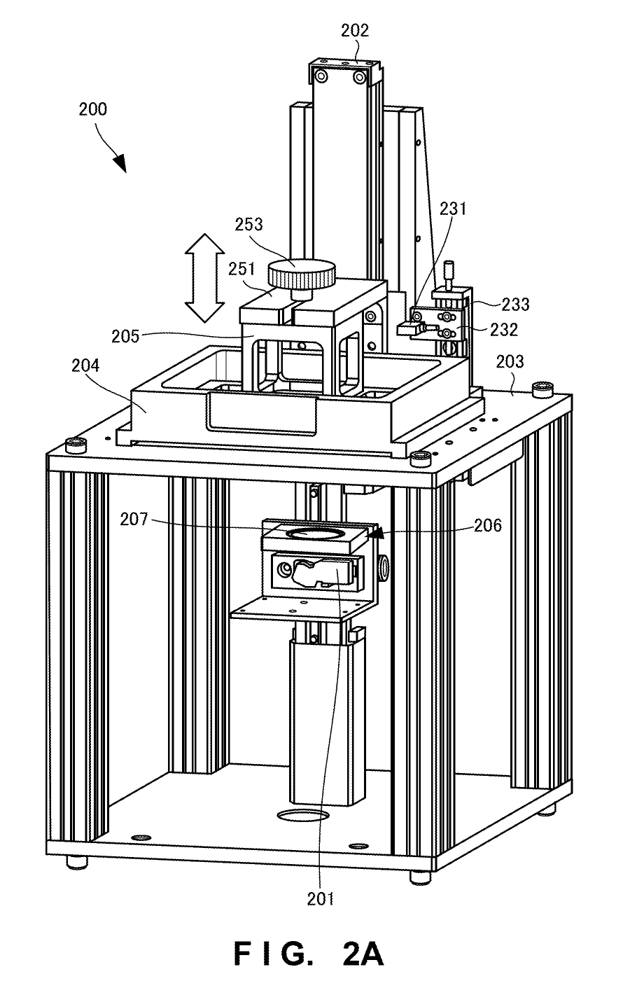

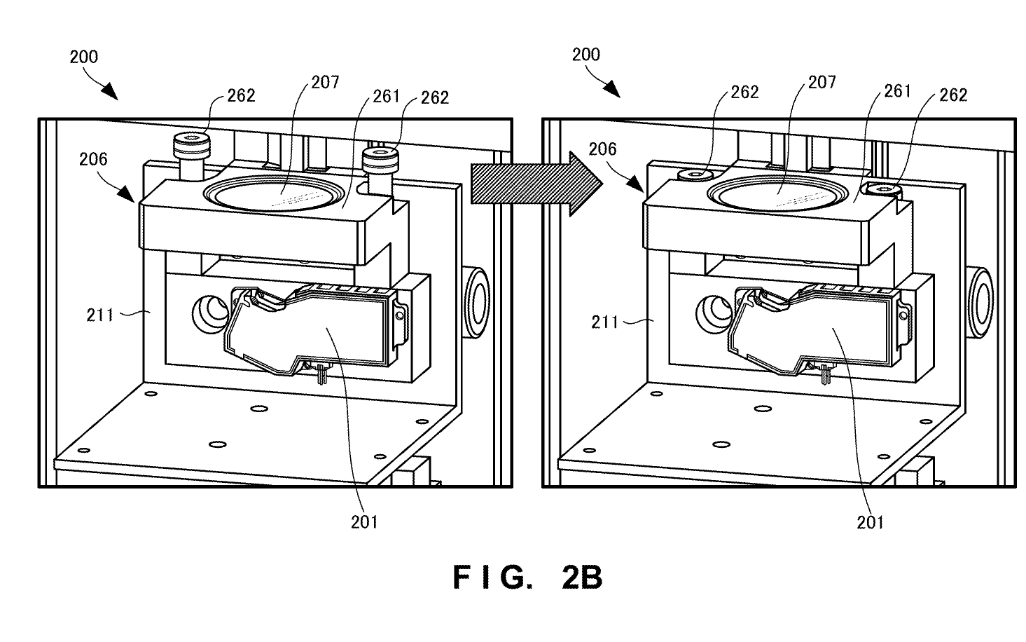

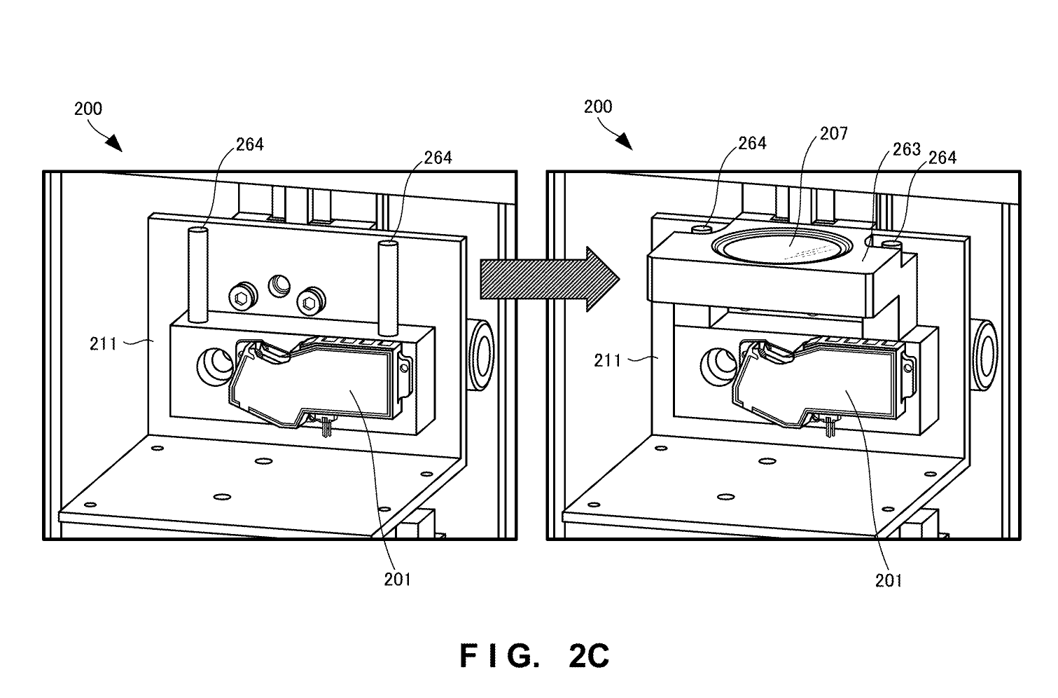

A three-dimensional shaping apparatus according to the second example embodiment of the present invention will be described with reference to FIGS. 2A to 2C. FIG. 2A is a view showing the overall arrangement of the three-dimensional shaping apparatus according to this example embodiment. FIG. 2B is a partially enlarged view showing an example of the attachment mechanism of the three-dimensional shaping apparatus according to this example embodiment.

A three-dimensional shaping apparatus 200 includes an optical engine 201, a column 202, a table 203, a material storage 204, a platform 205, and an attachment mechanism 206.

The optical engine 201 irradiates a material of a three-dimensional shaped object with a light beam. The material of the three-dimensional shaped object is, for example, a photo-curing resin.

The optical engine 201 is a high-output high-resolution engine. Note that the light beam emitted from the optical engine 201 has a wavelength of 405 nm but may have a wavelength of 200 nm to 400 nm. The present invention is not limited to this.

Although the detailed arrangement of the optical engine 201 is not shown, the optical engine 201 includes a light source, a reflecting mirror, a photodetector, and a two-dimensional MEMS (Micro Electro Mechanical System) mirror. The light source includes a semiconductor LD (Laser Diode) and a collimator lens. The semiconductor LD is a laser beam oscillation element that oscillates an ultraviolet laser beam or the like. Note that the laser beam oscillation element is not limited to the semiconductor LD and may be an LED (Light Emitting Diode). The two-dimensional MEMS mirror is a driving mirror that is driven based on an externally input control signal, and a device that vibrates to reflect the laser beam by changing an angle in the horizontal direction (X direction) and the vertical direction (Y direction). The optical engine 201 has a resolution of 720p or 1080p, and has a width of about 30 mm, a depth of about 15 mm, a height of about 7 mm, and a volume of about 3 cc. The number of semiconductor LDs arranged in the optical engine 201 may be one or more, and a necessary number of semiconductor LDs are arranged in accordance with the application purpose. The spot size of the light beam emitted from the optical engine 201 is 75 μm but can be changed appropriately in accordance with the application purpose.

The table 203 is attached to the column 202. A photosensor 231 is attached to the table 203 via a sensor supporter (sensor bracket) 232. The position of the photosensor 231 is adjusted using a sensor adjustment stage 233.

The material storage 204 is placed on the table 203. The material of the three-dimensional shaped object is charged and stored in the material storage 204. The bottom surface of the material storage 204 is formed by including a member capable of transmitting the light beam. The member capable of transmitting the light beam is represented by, for example, a glass member but the present invention is not limited to this. The entire material storage 204 may be formed by a member capable of transmitting the light beam. Note that the material storage 204 may be fixed to a predetermined position on the table 203 by a screw or the like, or may simply be placed on the table 203. A method of placing the material storage 204 on the table 203 is not limited to them.

The platform 205 is attached to a platform support member 251 by a platform mounting screw 253. In addition, the platform 205 is attached to the column 202 via the platform support member 251. The platform 205 can be detached from the platform support member 251 by loosening the platform mounting screw 253. The platform 205 can be fixed to the platform support member 251 by tightening the platform mounting screw 253.

The platform 205 is used to shape a three-dimensional shaped object. The platform 205 rises and lowers by a platform feeding mechanism, a stepping motor, and the like. That is, when shaping a three-dimensional shaped object, the platform 205 is aligned and lowered to a position where it contacts the bottom surface of the material storage 204. Then, while raising and pulling up the platform 205 from the state in which the platform 205 and the bottom surface of the material storage 204 are in contact with each other, the material is irradiated with the light beam, thereby shaping the three-dimensional shaped object. Note that the platform 205 is aligned using, for example, the photosensor 231. The position of the platform 205 can be detected using, for example, a contact bracket (not shown) and the photosensor 231. The position of the platform 205 can be detected in accordance with a position at which the contact bracket crosses the photosensor 231.

The platform 205 rises and lowers by the platform feeding mechanism, the stepping motor, and the like. The platform feeding mechanism is, for example, a high-rigidity ball screw feeding mechanism. The stepping motor is, for example, a high-torque stepping motor. Note that a structure that raises and lowers the platform 205 is not limited to the structure that uses the platform feeding mechanism and the stepping motor. The platform feeding mechanism is not limited to the ball screw feeding mechanism.

The platform feeding mechanism is a high-rigidity high-speed precision feeding mechanism. The rigidity, feeding speed, and feeding pitch of the platform are, for example, 3 kgw, 50 nm/sec, and 2.5 μm, respectively. The platform 205 is light in weight.

The attachment mechanism 206 is a mechanism for attaching, to a predetermined position, a lens unit 207 that condenses the light beam from the optical engine 201 serving as a light source. The attachment mechanism 206 is detachable from the three-dimensional shaping apparatus 200. As shown in the left and right views of FIG. 2B, the attachment mechanism 206 is attached to the three-dimensional shaping apparatus 200 by being fitted in a light source holder 211 that is used to attach and hold the optical engine 201. That is, a lens holder 261 is screwed in the light source holder 211 by screws 262. This attaches the lens holder 261 to the three-dimensional shaping apparatus 200.

The attachment mechanism 206 includes the lens holder 261 and the screws 262. The lens unit 207 is attached in advance to the lens holder 261. Then, the lens holder 261 attached with the lens unit 207 is attached to the light source holder 211 using the screws 262, thereby making it possible to attach the lens unit 207 to the three-dimensional shaping apparatus 200. In the lens holder 261, screw holes in which threads for screwing the screws 262 are cut are formed.

Note that the example in which the lens unit 207 including one type of lens is attached to one lens holder 261 has been explained. However, a lens unit 207 including a plurality of types of lenses may be attached to one lens holder 261. Alternatively, a plurality of lens holders 261 each attached with the lens unit 207 including one type of lens may be used.

If the lens unit 207 is attached to the three-dimensional shaping apparatus 200, the focus position of the light beam from the optical engine 201 changes. Therefore, the position of the optical engine 201 is adjusted in accordance with the focus position of the light beam. The position of the optical engine 201 is adjusted using a setting mechanism (not shown) provided in the light source holder 211, or the like. The setting mechanism is, for example, a mechanism for manually adjusting the position of the optical engine 201.

If, for example, the lens unit 207 is attached, the position of the optical engine 201 is moved upward, closer to the table 203. That is, since the focal length of the light beam is shortened by attaching the lens unit 207, the position of the optical engine 201 is made closer to the table 203 to shorten the distance between the optical engine 201 and the platform 205.

If no lens unit 207 is attached, for example, when the three-dimensional shaping apparatus 200 is used by detaching the attached lens holder 261, the focal length of the light beam from the optical engine 201 is increased, and it is thus necessary to lower the position of the optical engine 201. That is, the optical engine 201 is moved in a direction away from the table 203 to increase the distance between the optical engine 201 and the platform 205. Note that adjustment of the position of the optical engine 201 is not limited to the described setting method. The position is adjusted in accordance with the attached lens unit 207. The lens unit 207 attached to the lens holder 261 is a condenser lens that has a positive focal length, that is, positive refractive power.

FIG. 2C is a partially enlarged view showing another example of the attachment mechanism of the three-dimensional shaping apparatus according to this example embodiment. As shown in the left view of FIG. 2C, two shafts 264 are provided in the light source holder 211. Note that the number of shafts 264 provided in the light source holder 211 is not limited to two, and may be one or three or more.

Two holes into which the shafts 264 are inserted are formed in a lens holder 263 in correspondence with the shafts 264. The number of holes formed in the lens holder 263 corresponds to the number of shafts 264. As shown in the right view of FIG. 2C, the lens holder 263 is inserted into the two shafts 264 from above, thereby attaching the lens holder 263 to the light source holder 211. The position of the optical engine 201 is adjusted in accordance with the presence/absence of attachment of the lens unit 207.

A shaping size when the lens unit 207 is used is, for example, a size of 52 mm×37 mm. If the lens unit 207 is used, the three-dimensional shaping apparatus 200 can perform small-size high-resolution shaping. A shaping size when no lens unit 207 is used is, for example, a size of 142 mm×80 mm. If no lens unit 207 is used, the three-dimensional shaping apparatus 200 can perform large-size shaping. Note that the size in the case of small-size shaping and that in the case of large-size shaping are not limited to the above-described examples. The shaping size can be changed appropriately in accordance with the lens unit 207 used.

According to this example embodiment, since the focal length of the light beam from the optical engine 201 can be changed in accordance with the presence/absence of attachment of the lens unit 207, shaping of a large-size three-dimensional shaped object and shaping of a small-size high-resolution three-dimensional shaped object can be performed by one three-dimensional shaping apparatus 200. Furthermore, it is possible to attach/detach the lens unit easily.

### Third Example Embodiment

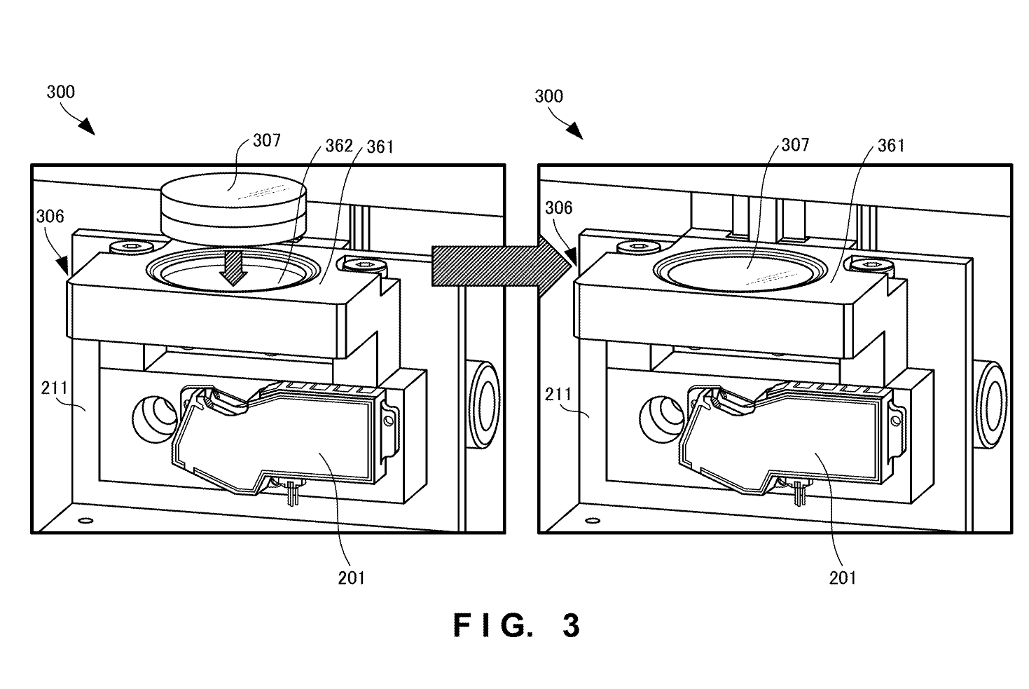

A three-dimensional shaping apparatus according to the third example embodiment of the present invention will be described with reference to FIG. 3. FIG. 3 is a view showing an example of the attachment arrangement of the three-dimensional shaping apparatus according to this example embodiment. The three-dimensional shaping apparatus according to this example embodiment is different from the above-described second example embodiment in that a lens unit is detachable from a lens holder. The remaining components and operations are the same as those in the second example embodiment. Hence, the same reference numerals denote the same components and operations, and a detailed description thereof will be omitted.

A three-dimensional shaping apparatus 300 includes an attachment mechanism 306. A lens unit 307 is attached in a hole 362, formed in a lens holder 361, for attaching the lens unit 307. The lens unit 307 is inserted (attached and stored) into the hole 362, as shown in the left view of FIG. 3. In this case, in the hole 362, a projecting portion (not shown) on which the lens unit 307 is placed, that is, a portion projecting inside on which the lens unit 307 is placed is provided. This projecting portion may be provided on the entire periphery of the hole 362 or partially provided on the periphery of the hole 362.

As shown in the right view of FIG. 3, the lens unit 307 is placed in the hole 362, thereby making it possible to attach the lens unit 307 to the three-dimensional shaping apparatus 300. In this case, the lens holder 361 is attached in advance to a light source holder 211 or the like.

Threads may be formed in the lens unit 307 and the hole 362, and the lens unit 307 may be screwed in the lens holder 361. If the lens unit 307 is screwed in this way, the lens unit 307 can be fixed to the lens holder 361 reliably. A pressing ring may be screwed from above the lens unit 307.

According to this example embodiment, since the lens unit is placed or screwed in the lens holder, it is possible to attach/detach the lens unit easily, and fix the lens unit to the lens holder reliably.

### Fourth Example Embodiment

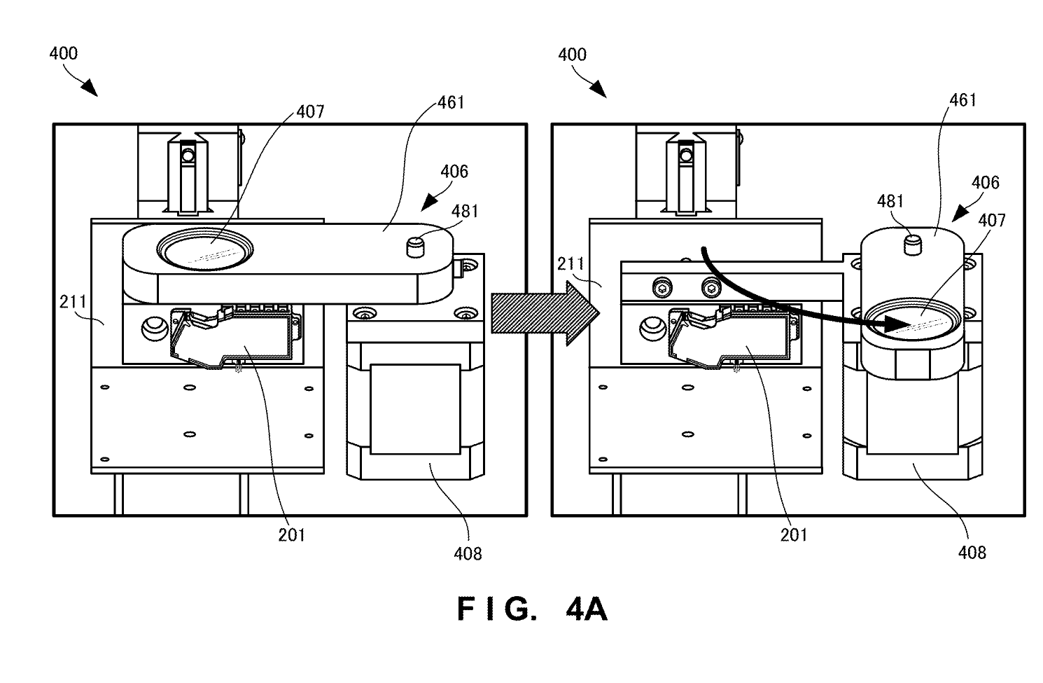

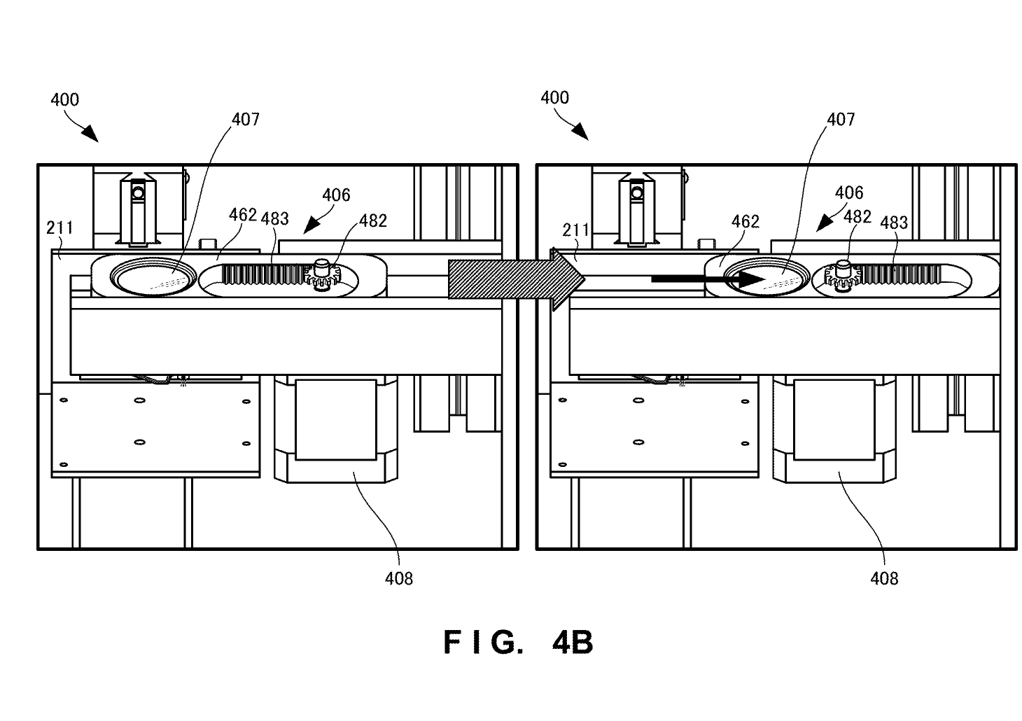

A three-dimensional shaping apparatus according to the fourth example embodiment of the present invention will be described with reference to FIGS. 4A and 4B. FIG. 4A is a partially enlarged view showing an example of the attachment mechanism of the three-dimensional shaping apparatus according to this example embodiment. The three-dimensional shaping apparatus according to this example embodiment is different from the above-described second and third example embodiments in that a moving mechanism is provided as the attachment mechanism. The remaining components and operations are the same as those in the second example embodiment. Hence, the same reference numerals denote the same components and operations, and a detailed description thereof will be omitted.

A three-dimensional shaping apparatus 400 includes a moving mechanism 406 as an attachment mechanism that attaches a lens unit 407 to a predetermined position. The moving mechanism 406 includes a rotating mechanism that rotates the attachment mechanism about a predetermined shaft. The moving mechanism 406 includes a lens holder 461, and the lens holder 461 is attached with the lens unit 407. The lens holder 461 rotates about a rotating shaft 481 in accordance with movement of a motor 408. This allows the lens unit 407 to move between an attachment position and a non-attachment position.

Since the lens holder 461 rotates about the rotating shaft 481, the lens unit 407 moves to the attachment position of the lens unit 407, that is, onto the path of a light beam from an optical engine 201, as shown in the left view of FIG. 4A. As shown in the right view of FIG. 4A, the lens unit 407 moves to the non-attachment position of the lens unit 407, that is, a position (a position where no light beam is blocked) away from the path of the light beam from the optical engine 201, as shown in the right view of FIG. 4A. With the moving mechanism 406, the lens unit 407 can be automatically attached or released (detached). Note that the example of moving the lens holder 461 by the motor 408 has been explained. However, the lens holder 461 may be rotated and moved manually, instead of using the motor 408.

FIG. 4B is a partially enlarged view showing another example of the attachment mechanism of the three-dimensional shaping apparatus according to this example embodiment. The three-dimensional shaping apparatus 400 includes the moving mechanism 406 including a slide mechanism. The slide mechanism includes a lens holder 462. The lens unit 407 is attached to the lens holder 462, and slides by the slide mechanism. A gear 482 is attached to the rotating shaft of the motor 408 so that the gear 482 meshes with a groove (rack) 483 provided in the lens holder 462. Therefore, the lens holder 462 slides in accordance with the movement of the gear 482. Note that the groove 483 is formed on one inner side of the lens holder 462.

If the motor 408 is rotated, the lens holder 462 slides rightward (moves in the horizontal direction), and thus the lens unit 407 also moves rightward, as shown in the left and right views of FIG. 4B. Then, the lens unit 407 moves to a non-attachment position as a position (a position where no light beam is blocked) away from the path of the light beam from the optical engine 201.

If the motor 408 is reversely rotated, the lens holder 462 slides leftward, and thus the lens unit 407 also moves leftward. Then, the lens unit 407 moves to a position (attachment position) on the path of the light beam from the optical engine 201. With this moving mechanism 406, the lens unit 407 can be automatically attached or released (detached). Note that the example of moving the lens holder 462 by the motor 408 has been explained. However, the lens holder 462 may be slid manually, instead of using the motor 408.

According to this example embodiment, it is possible to automatically move the lens unit. Therefore, it is possible to attach/detach the lens unit easily, quickly, and reliably.

### Fifth Example Embodiment

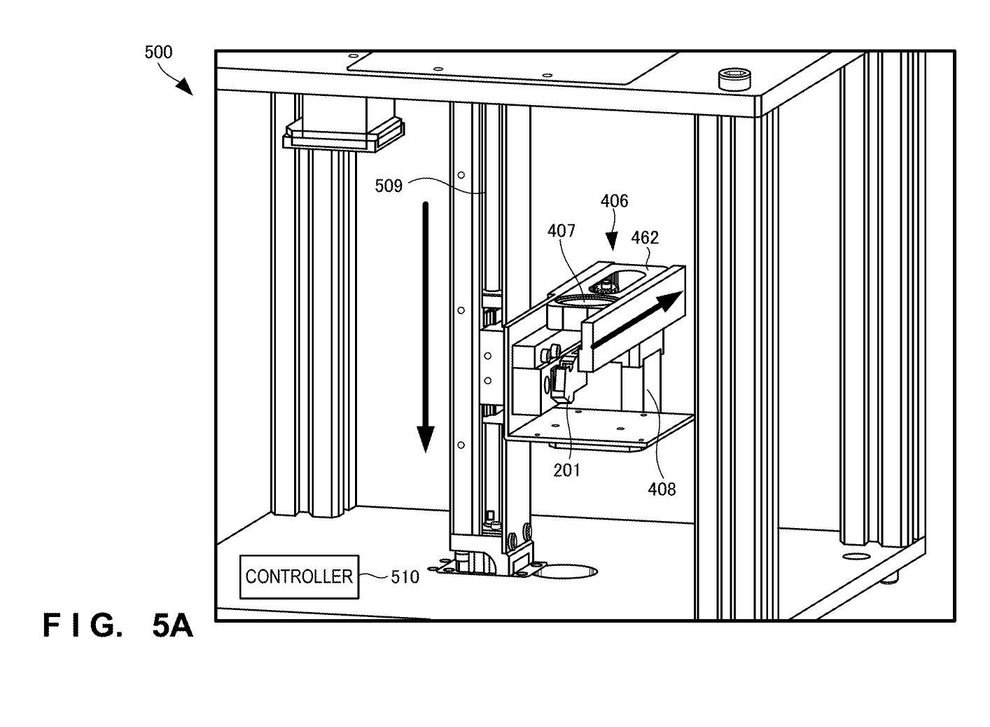

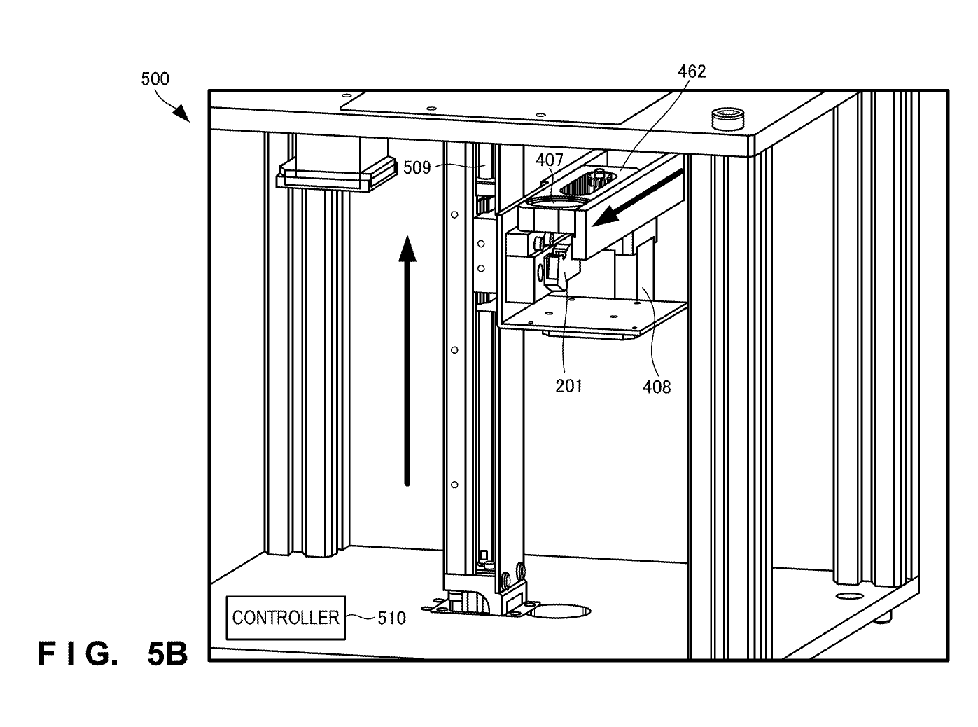

A three-dimensional shaping apparatus according to the fifth example embodiment of the present invention will be described with reference to FIGS. 5A to 7. FIG. 5A is a partially enlarged view showing an example of the attachment mechanism of the three-dimensional shaping apparatus according to this example embodiment. FIG. 5B is another partially enlarged view showing an example of the attachment mechanism of the three-dimensional shaping apparatus according to the fifth example embodiment of the present invention. The three-dimensional shaping apparatus according to this example embodiment is different from the above-described second to fourth example embodiments in that a controller is provided. The remaining components and operations are the same as those in the second to fourth example embodiments. Hence, the same reference numerals denote the same components and operations, and a detailed description thereof will be omitted.

A three-dimensional shaping apparatus 500 includes an optical engine 201, a moving mechanism 406, a lens unit 407, a motor 408, a linear actuator 509, and a controller 510.

The moving mechanism 406 moves the lens unit 407 between an attachment position and a non-attachment position. The motor 408 drives the moving mechanism 406 to move between the attachment position and the non-attachment position. This causes the lens unit 407 to move between the attachment position and the non-attachment position, thereby automatically attaching detaching the lens unit 407. Note that the moving mechanism 406 for moving the lens unit 407 moves the lens unit 407 by a slide mechanism described with reference to FIG. 4B.

The controller 510 controls movement (attachment/detachment) of the lens unit 407 and position adjustment of the optical engine 201 in synchronism with each other. That is, if, as shown in FIG. 5A, no lens unit 407 is used (attached), the controller 510 controls movement of the lens unit 407 to the non-attachment position and position adjustment (downward movement) of the optical engine 201 to synchronize with each other. If, as shown in FIG. 5B, the lens unit 407 is used (attached), the controller 510 controls movement of the lens unit 407 to the attachment position and position adjustment (upward movement) of the optical engine 201 to synchronize with each other.

Therefore, if, for example, the user of the three-dimensional shaping apparatus 500 selects use or nonuse of the lens unit 407, the controller 510 automatically sets the position of the optical engine 201. If, for example, the user of the three-dimensional shaping apparatus 500 selects the position of the optical engine 201, the controller 510 automatically sets the attachment or non-attachment position of the lens unit 407.

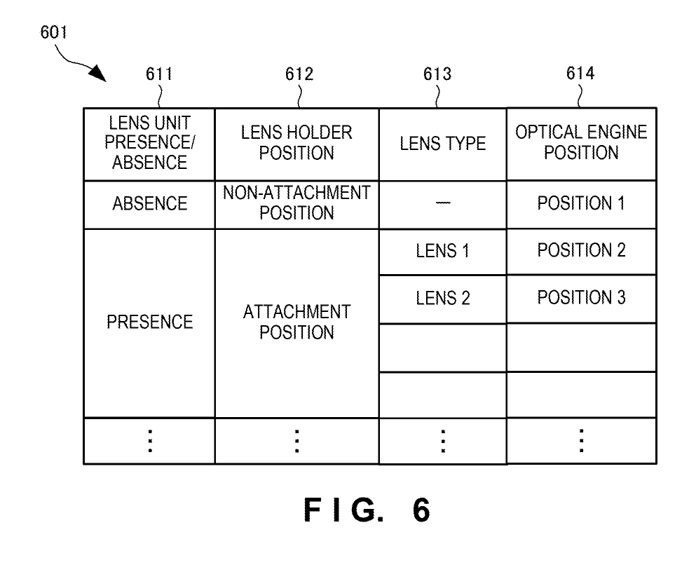

FIG. 6 is a table showing an example of a synchronization table provided in the three-dimensional shaping apparatus according to this example embodiment. A synchronization table 601 stores a lens holder position 612, a lens type 613, and an optical engine position 614 in association with lens unit presence/absence 611. The lens unit presence/absence 611 indicates whether or not to use the lens unit 407. The lens holder position 612 indicates the position of a lens holder 462, that is determined in accordance with the presence/absence of use of the lens unit 407. The lens type 613 indicates information about a lens included in the lens unit 407, and information concerning the performance of the lens and the like. The optical engine position 614 indicates the position of the optical engine 201, that is determined in accordance with the presence/absence of the lens unit 407 and the type of the lens used as the lens unit 407. The synchronization table 601 is stored in, for example, the storage (not shown) of the three-dimensional shaping apparatus 500. The controller 510 controls movement of the lens unit 407 and position adjustment of the optical engine 201 in synchronism with each other with reference to the synchronization table 601.

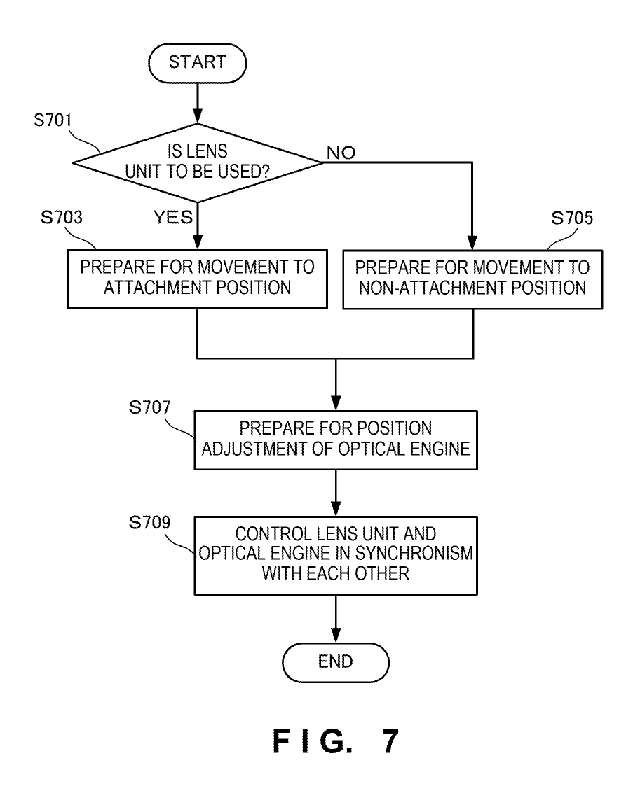

FIG. 7 is a flowchart illustrating the operation procedure of the three-dimensional shaping apparatus according to this example embodiment. This flowchart is executed by a CPU (Central Processing Unit) of the controller 510. In step S701, the three-dimensional shaping apparatus 500 determines whether to use the lens unit 407. If it is determined to use the lens unit 407 (YES in step S703), the three-dimensional shaping apparatus 500 advances to step S703. In step S703, the three-dimensional shaping apparatus 500 prepares for moving the lens unit 407 to the attachment position. If it is determined not to use the lens unit 407 (NO in step S701), the three-dimensional shaping apparatus 500 advances to step S705. In step S705, the three-dimensional shaping apparatus 500 prepares for moving the lens unit 407 to the non-attachment position.

In step S707, the three-dimensional shaping apparatus 500 prepares for position adjustment of the optical engine 201 in accordance with the position of the lens unit 407. That is, a specific position is determined as the position of the optical engine 201. In step S709, the three-dimensional shaping apparatus 500 controls movement of the lens unit 407 and position adjustment of the optical engine 201 to synchronize with each other. That is, movement of the lens unit 407 and that of the optical engine 201 are controlled so as to synchronize with each other.

According to this example embodiment, since movement of the lens unit to the attachment positon and non-attachment position and position adjustment of the optical engine are controlled in synchronism with each other, it is possible to make setting of the apparatus easily, quickly, and correctly. In addition, it is possible to automatically set a focal length in accordance with the lens unit used.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

What is claimed is:

1. A three-dimensional shaping apparatus comprising:
an attachment mechanism that attaches, to a predetermined position, a lens unit that condenses a light beam from a light source; and
an adjustment mechanism that adjusts a position of the light source in accordance with the attached lens unit.

2. The apparatus according to claim 1, wherein said attachment mechanism includes
a lens holder that is attached with the lens unit, and
a fitting unit that fits said lens holder in a light source holder that holds the light source.

3. The apparatus according to claim 2, wherein the lens unit is screwed in said lens holder.

4. The apparatus according to claim 2, wherein the lens unit is attached to said lens holder using a pressing ring.

5. The apparatus according to claim 1, wherein said attachment mechanism includes a moving mechanism that can move the lens unit between an attachment position of the lens unit and a non-attachment position of the lens unit.

6. The apparatus according to claim 5, wherein said moving mechanism includes a slide mechanism that slides the lens unit between the attachment position and the non-attachment position.

7. The apparatus according to claim 5, wherein said moving mechanism includes a rotating mechanism that rotates said attachment mechanism about a predetermined shaft, and moves the lens unit between the attachment position and the non-attachment position.

8. The apparatus according to claim 6, further comprising a first driver that drives said moving mechanism to move between the attachment position and the non-attachment position.

9. The apparatus according to claim 7, further comprising a first driver that drives said moving mechanism to move between the attachment position and the non-attachment position.

10. The apparatus according to claim 1, wherein said adjustment mechanism includes a setting mechanism that sets one of a first position of the light source obtained when the lens unit is attached and a second position of the light source obtained when the lens unit is not attached.

11. The apparatus according to claim 1, further comprising a second driver that drives said adjustment mechanism to adjust the position of the light source between a first position of the light source obtained when the lens unit is attached and a second position of the light source obtained when the lens unit is not attached.

12. The apparatus according to claim 11, further comprising a controller that controls said first driver and said second driver in synchronism with each other.

13. A control method of a three-dimensional shaping apparatus including
an attachment mechanism that attaches, to a predetermined position, a lens unit that condenses a light beam from a light source, and
an adjustment mechanism that adjusts a position of the light source in accordance with the attached lens unit,
the attachment mechanism including a moving mechanism that can move the lens unit between an attachment position of the lens unit and a non-attachment position of the lens unit,
the method comprising:
driving the moving mechanism to move between the attachment position of the lens unit and the non-attachment position of the lens unit;
driving the adjustment mechanism to adjust the position of the light source between a first position of the light source obtained when the lens unit is attached and a second position of the light source obtained when the lens unit is not attached; and
controlling the driving the moving mechanism and the driving the adjustment mechanism to synchronize with each other.

14. A non-transitory computer readable medium storing a control program of a three-dimensional shaping apparatus including
an attachment mechanism that attaches, to a predetermined position, a lens unit that condenses a light beam from a light source, and
an adjustment mechanism that adjusts a position of the light source in accordance with the attached lens unit,
the attachment mechanism including a moving mechanism that can move the lens unit between an attachment position of the lens unit and a non-attachment position of the lens unit,
the program for causing a computer to execute a method, comprising:
driving the moving mechanism to move between the attachment position of the lens unit and the non-attachment position of the lens unit;
driving the adjustment mechanism to adjust the position of the light source between a first position of the light source obtained when the lens unit is attached and a second position of the light source obtained when the lens unit is not attached; and
controlling the driving the moving mechanism and the driving the adjustment mechanism to synchronize with each other.
